(19) United States
(12) Patent Application Publication
(10) Pub. No.: US 2014/0161535 A1
(43) Pub. Date: Jun. 12, 2014

(54) LAYING OFFSHORE PIPELINES

(71) Applicant: Rafael Machado Guigon De Araujo, Rio de Janeiro (BR)

(72) Inventor: Rafael Machado Guigon De Araujo, Rio de Janeiro (BR)

(21) Appl. No.: 13/991,420

(22) PCT Filed: Dec. 5, 2011
(86) PCT No.: PCT/IB2011/055459

§ 371 Date: Jan. 26, 2014

(30) Foreign Application Priority Data
Dec. 3, 2010 (GB) 1020540.9

(51) Int. Cl. F16L 1/23; B63B 35/03; F16L 1/16

(52) U.S. Cl. CPC F16L 1/23; F16L 1/16; B63B 35/03
USPC 405/168.4

(57) ABSTRACT

An apparatus for laying pipe from a vessel is disclosed. The apparatus includes a traveling working table that can be lowered to allow clearance for horizontal movement of a tensioner over an in-line structure. Another embodiment employs a main working table, a tensioner positioned above the main working table, and an auxiliary working table positioned below the main working table. The auxiliary working table can be lowered to accommodate an in-line structure, which lies in a gap extending from the tensioner through the level of the main working table to the level of the auxiliary working table. The apparatus enables the tensioner to be mounted lower on the vessel to benefit stability and cost and to facilitate retrofit of the apparatus to existing vessels.

This application is the U.S. National Phase of International Application Number PCT/GB2011/055459 filed on Dec. 5, 2011, which claims priority to Great Britain Application Number 1020540.9 filed on Dec. 3, 2010.

This invention relates to apparatus and methods for laying pipe from a pipelaying vessel.

When pipe is being laid from a vessel, a portion of the pipe known as the catenary is suspended between the vessel and the seabed. The weight of the catenary must be supported by the vessel's pipelaying equipment, which applies tension to the catenary as the pipe is being laid. For this purpose, it is common in the industry to provide pipelaying vessels with tensioners, such as track-type tensioners as described in U.S. Pat. No. 5,527,134. Tensioners grip the pipe to maintain the necessary tension while allowing the pipe to move axially into the water and toward the seabed.

The increasing demand for pipelines to be laid in deep water has led to significant developments in tensioners. As a rule, the deeper the water, the longer and heavier the catenary and the larger the tensioner must therefore be to grip and apply the necessary tension to the pipe. Typical tensioners are therefore very heavy and bulky, particularly in terms of their length of contact with the pipe and hence their height, given the near-vertical departure angle that is favoured for deep-water pipelaying.

Where pipelaying equipment is mounted on a laytower of the vessel, the use of heavy and tall tensioners affects the stability of the vessel. This problem may require the hull of the vessel to be larger and hence more costly than it would otherwise need to be. Also, it is difficult to increase the capacity of an existing vessel without compromising its stability.

The requirement to incorporate in-line structures such as in-line tees in the pipeline further raises the centre of gravity of the vessel because such in-line structures must be accommodated under the tensioner. It is also necessary to allow sufficient clearance above the in-line structure for an upper connector.

Typically, in-line structures are connected to the top end of the pipeline once a working table has clamped that end to support the load of the catenary. The working table is situated around deck level; it allows the tensioner to be disengaged from the pipeline and if necessary retracted (for example, moved aside) to allow the in-line structure to be connected. Once the in-line structure has been connected, the tensioner is re-positioned above the in-line structure to take the load of the catenary (now including the in-line structure) back off the working table.

It follows that the vertical distance between the tensioner and the working table must be substantially greater than the height of the in-line structure. The result is that the great weight of the tensioner is mounted undesirably high above the deck level of the vessel.

The Applicant's prior international patent application published as WO 2009/022189 discloses a travelling clamp that may be used simultaneously with a tensioner to lay a pipe. The travelling clamp and the tensioner thereby share the load of the catenary, minimising the required capacity of the tensioner. However, WO 2009/022189 takes the approach of using a small-capacity tensioner—which cannot be used without the assistance of the travelling clamp in all circumstances—rather than considering how best to position a tensioner whose capacity is large enough to be used alone in most or all circumstances. Also, the use of a travelling clamp slows the pipelaying process somewhat, due to repeated return strokes of the clamp.

Against this background, the invention resides in a pipelaying vessel in combination with a pipe incorporating an in-line structure. The vessel comprises a clamp supporting a catenary of the pipe extending from the vessel to the seabed, the clamp being located at a level below, or being movable to a level below, a working deck of the vessel. The in-line structure is positioned above the clamp, connected to an upper end of the catenary supported by the clamp. A tensioner is positioned with a vertical clearance above the working deck and is movable transversely with respect to a launch axis of the pipe from a retracted position to a deployed position above the in-line structure. The in-line structure has a height along the launch axis that exceeds the vertical clearance between the working deck and the tensioner and the level of the clamp is below the working deck by a distance sufficient to accommodate the in-line structure under the tensioner when the tensioner is in the deployed position.

The invention may also be expressed as a subsea pipelaying method, comprising: supporting a catenary of pipe extending to the seabed from a clamp located at, or movable to, a level below a working deck of a pipelaying vessel; connecting an in-line structure to an upper end of the catenary supported by the clamp when the clamp is below the working deck or before moving the clamp below the working deck: and with the clamp below the working deck to allow a tensioner positioned above the working deck to clear the top of the in-line structure, moving the tensioner transversely with respect to a launch axis of the pipe from a retracted position to a deployed position above the in-line structure.

Where the pipe incorporates an in-line structure positioned above the clamp whose height along the launch axis exceeds a vertical clearance between the working deck and the tensioner, the level of the clamp is below the working deck by a distance sufficient to accommodate the in-line structure under the tensioner when the tensioner is in the deployed position. The height of the in-line structure along the launch axis may, in practice, include one or more connectors for connecting the in-line structure to upper and/or lower sections of the pipe.

The invention enables the tensioner to be kept low, to the benefit of centre of gravity and hence stability of the vessel while still allowing ample vertical clearance between the tensioner and the in-line structure. This also has cost benefits and allows the apparatus to be retrofitted to existing vessels.

The clamp is suitably situated on a hull wall of the vessel extending from the working deck to below a waterline of the vessel. For example, the clamp may be situated in a laying slot or moonpool of the vessel.

The clamp is suitably movable in the direction of lay to lower the clamped pipe, and may have a range of movement extending below the waterline of the vessel. Preferably, for ease of access, the clamp has a range of movement sufficient to bring an upper end of the in-line structure to or near to the level of a working deck of the vessel. A platform may be moved from the deck or from another structure such as a laytower toward the upper end of the in-line structure for access by workers thereto.

Advantageously, the clamp may comprise elements such as jaws that are movable between stowed and deployed states. For example, in the stowed state, the elements of the clamp may lie against or generally parallel with hull walls of the vessel, such as was of a moonpool or a laying slot of the vessel. This maintains clearance for overboarding the pipe and its accessories during normal pipelaying operations. It is also possible for the elements of the clamp to lie beneath the waterline when stowed, although they may be stowed above the waterline as an alternative.

Conversely, in the deployed state, the elements of the clamp may lie proud of the hull walls of the vessel, such as being oriented generally orthogonally with respect to those walls. In the deployed state, the elements are positioned to clamp the pipe between them when required, and to define a working table.

Thus, it is preferred that the elements of the clamp are pivotable with respect to the hull walls. The elements of the clamp may also be mounted to respective carriages that are movable along upright rails attached to the hull walls. Such carriages may conveniently be used for pivotal mounting of the elements of the clamp.

References in this specification to a clamp or to the act of clamping are intended to encompass both frictional and non-frictional engagement of the pipe with a support, for example as between complementary inter-engaging formations of jaws of a clamp and a pipe or connectors associated with a pipe.

References in this specification to a pipe or pipeline are intended to include connectors or other accessories associated with the pipe, unless the context demands otherwise.

In order that the invention may be mare readily understood, reference will now be made, by way of example, to the accompanying drawings in which:

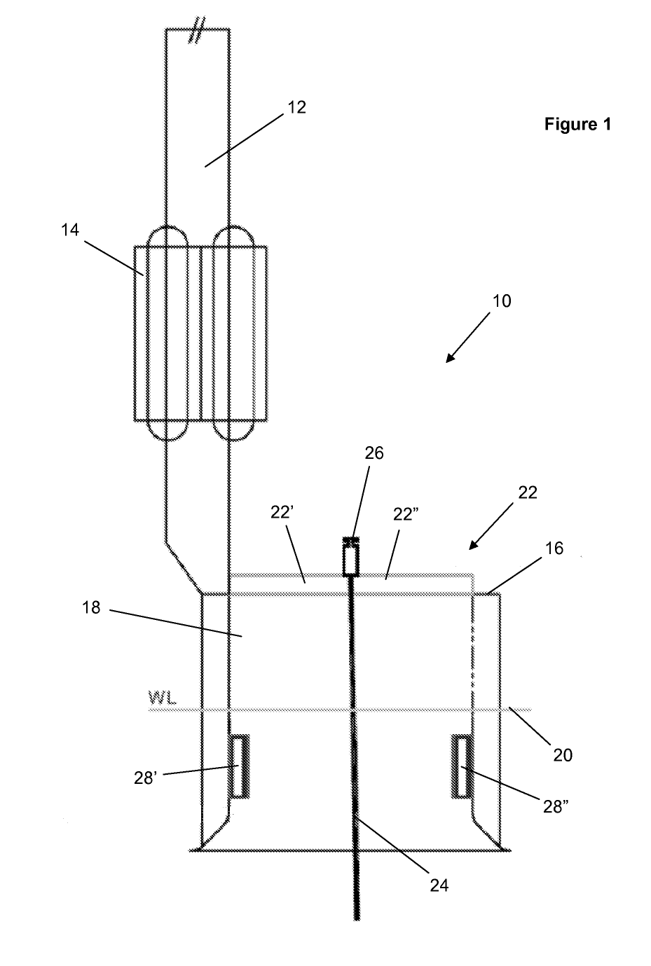

FIG. 1 is a schematic side view of apparatus on a pipelaying vessel, comprising a main working table that clamps a lower pipe section hanging from the main working table as a catenary, the apparatus being adapted in accordance with the invention by the addition of a travelling auxiliary working table shown here in a stowed state under the main working table,

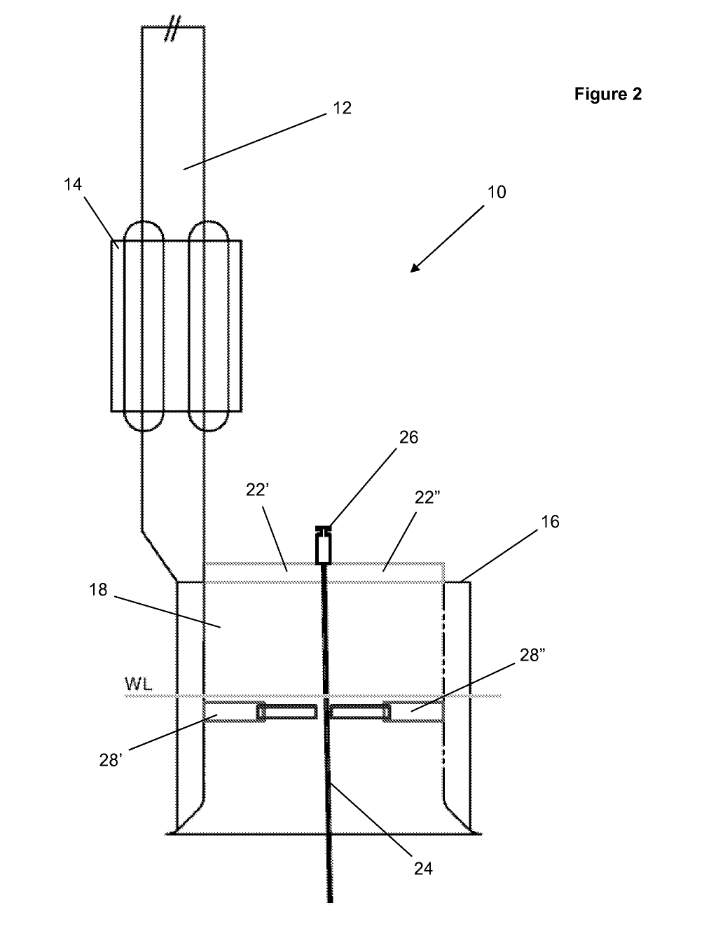

FIG. 2 corresponds to FIG. 1 but shows the auxiliary working table in a deployed state;

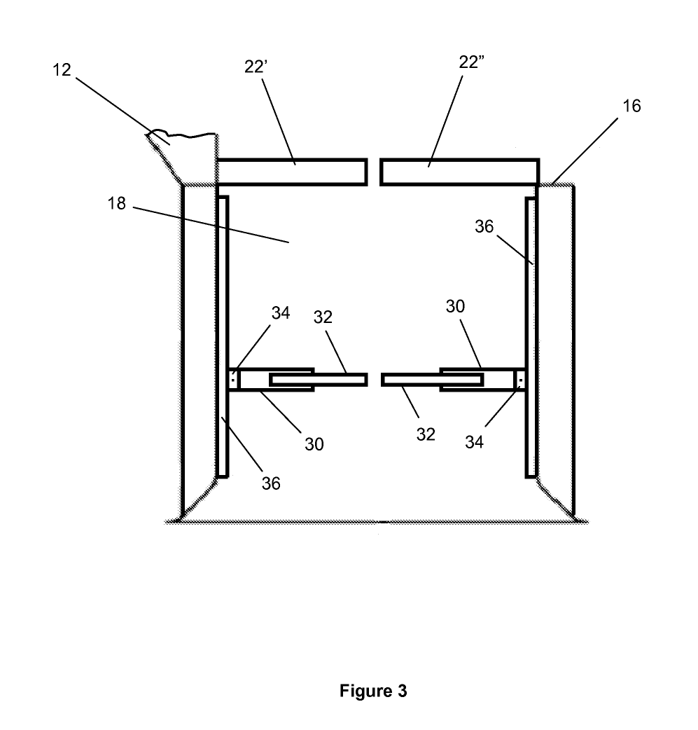

FIG. 3 is an enlarged view of the apparatus shown in FIG. 2, with the lower pipe section omitted for clarity;

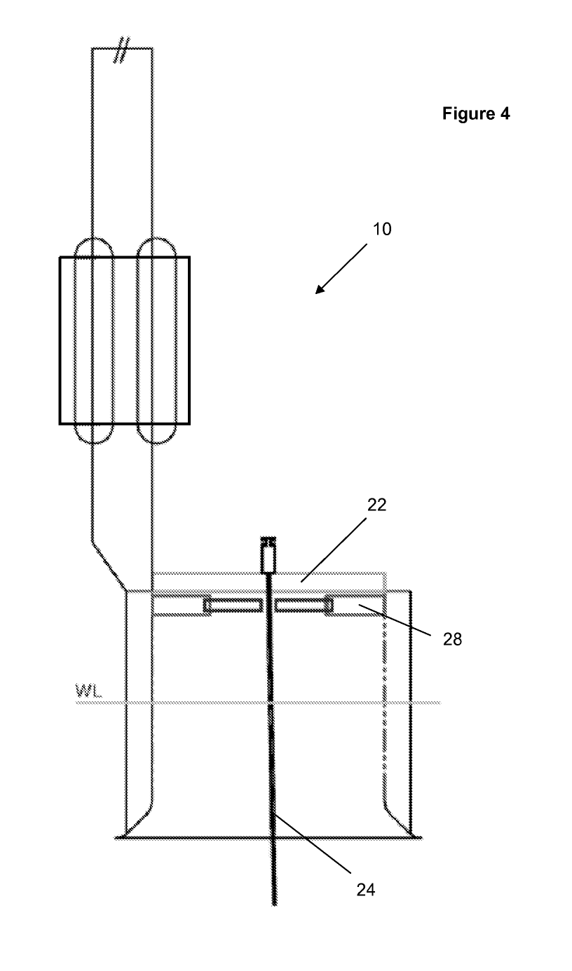

FIG. 4 corresponds to FIG. 2 but shows the deployed auxiliary working table in a raised position immediately under the main working table that still clamps the lower pipe section;

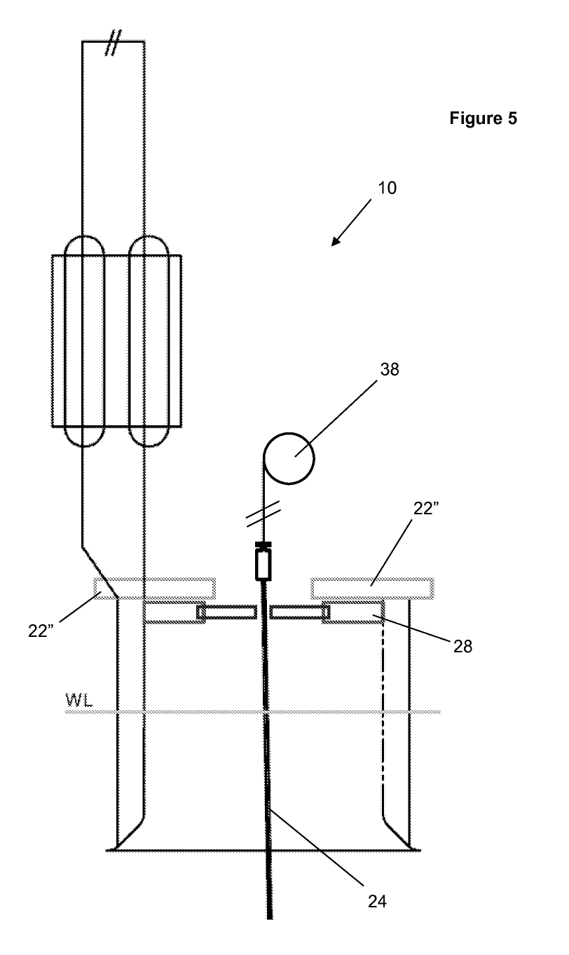

FIG. 5 corresponds to FIG. 4 but shows the lower pipe section being lifted from the main working table, which has now released the lower pipe section;

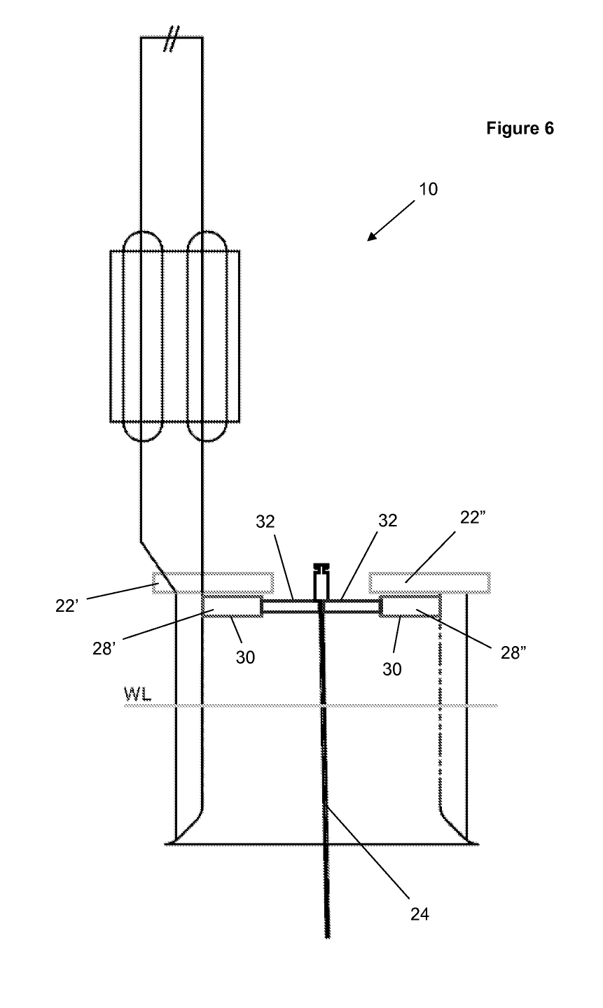

FIG. 6 corresponds to FIG. 5 but shows the lower pipe section now clamped by the auxiliary working table, from which the pipe hangs such that the auxiliary working table bears the load of the catenary;

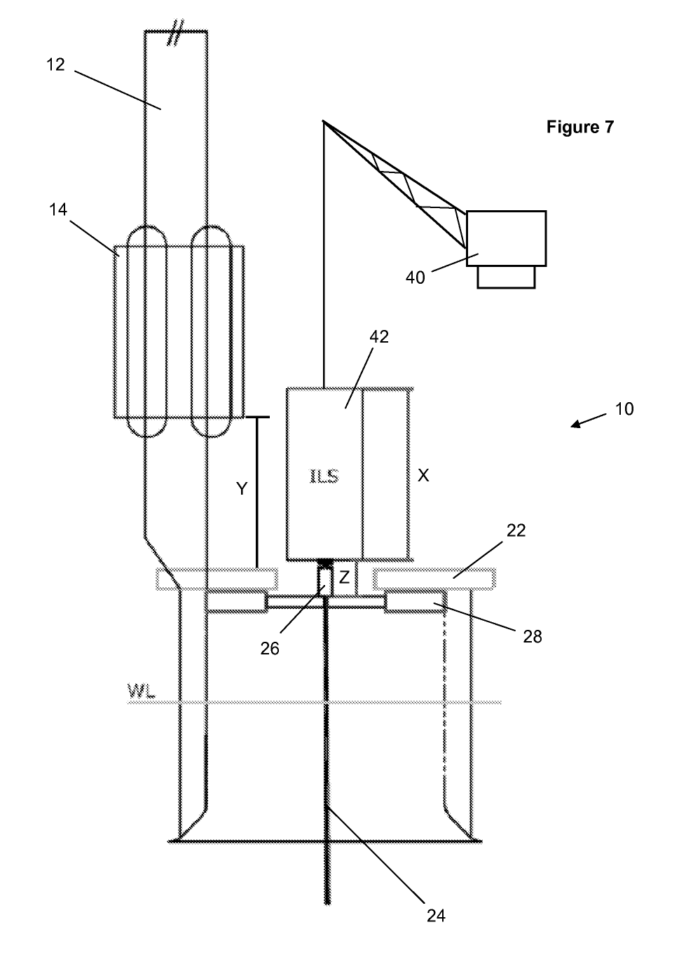

FIG. 7 corresponds to FIG. 6 but shows an in-line structure connected to a connector fitting attached to the top end of the lower pipe section, which still hangs from the auxiliary working table;

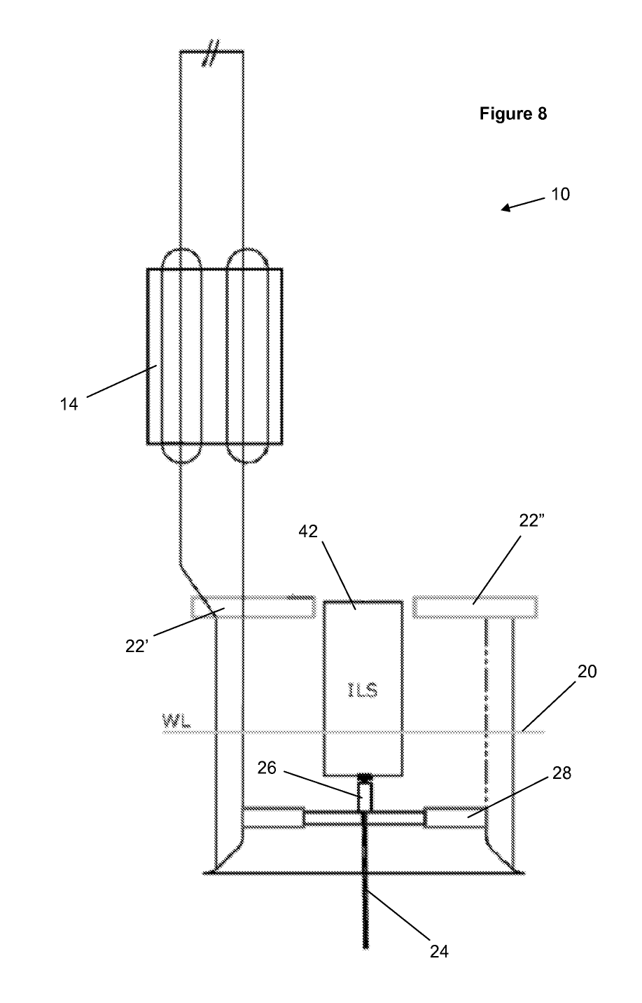

FIG. 8 corresponds to FIG. 7 but shows the auxiliary working table in a lowered position enabling the in-line structure to be lowered to an extent that provides clearance for a tensioner to be moved over the in-line structure:

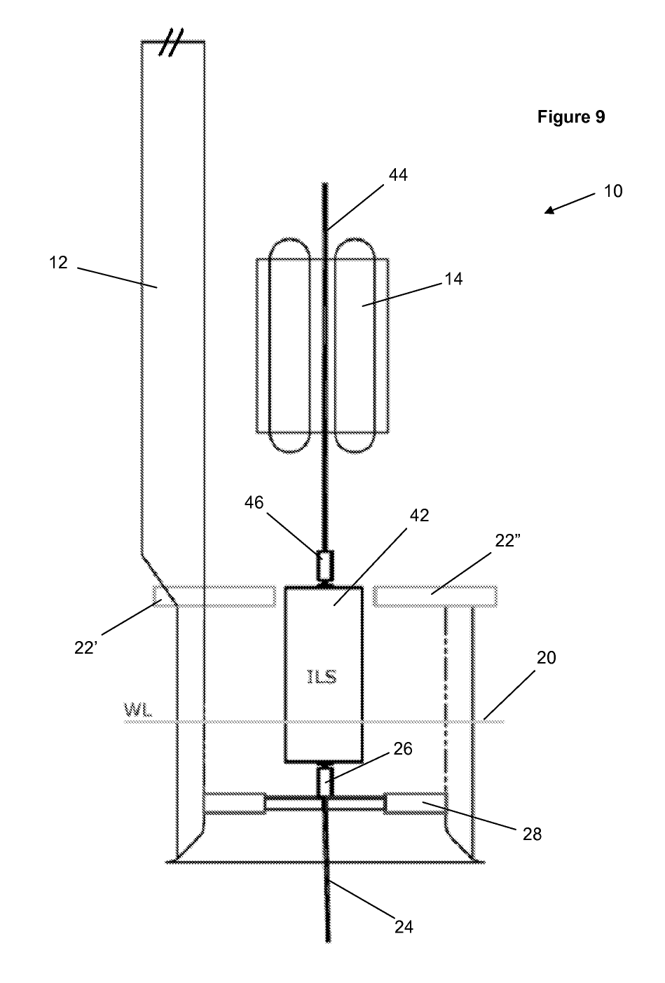

FIG. 9 corresponds to FIG. 8 but shows the tensioner positioned over the in-line structure to engage an upper pipe section connected to the in-line structure via another connector fitting, while the lower pipe section still hangs from the auxiliary working table which bears the load of the catenary:

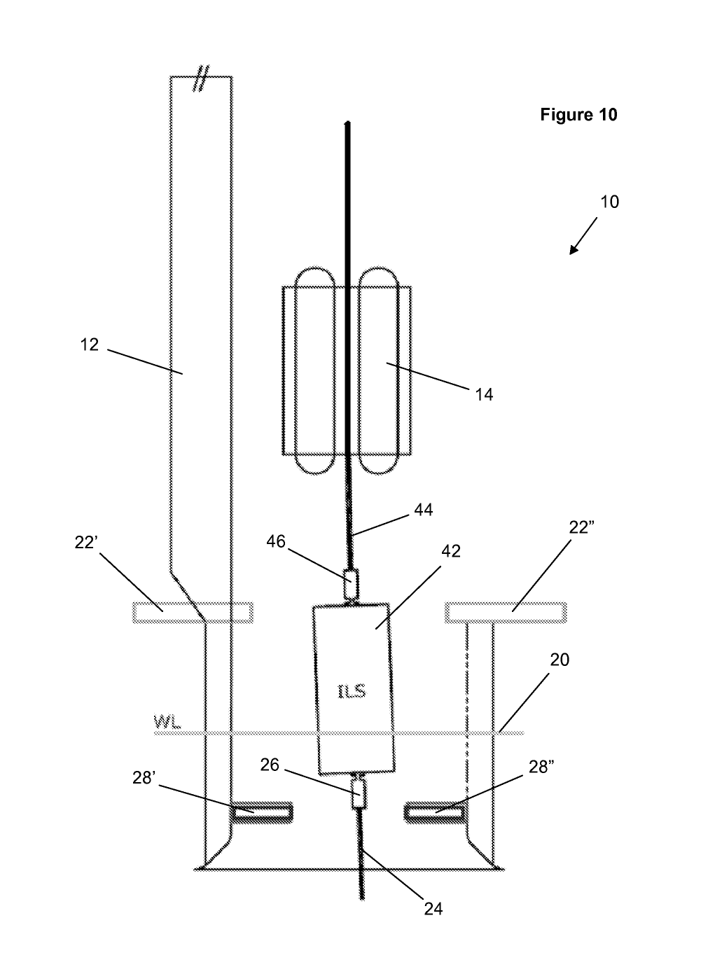

FIG. 10 corresponds to FIG. 9 but shows the auxiliary working table having released the lower pipe section now that the tensioner engaged with the upper pipe section carries the load of the in-line structure and the catenary;

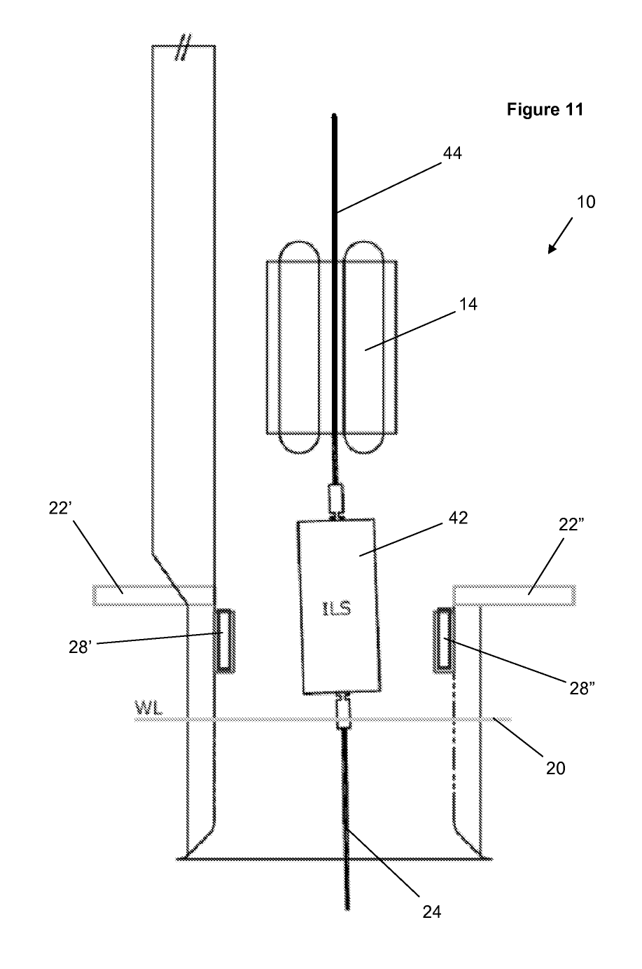

FIG. 11 corresponds to FIG. 10 but shows the in-line structure hauled in to an extent necessary to allow the auxiliary working table to return to the stowed state;

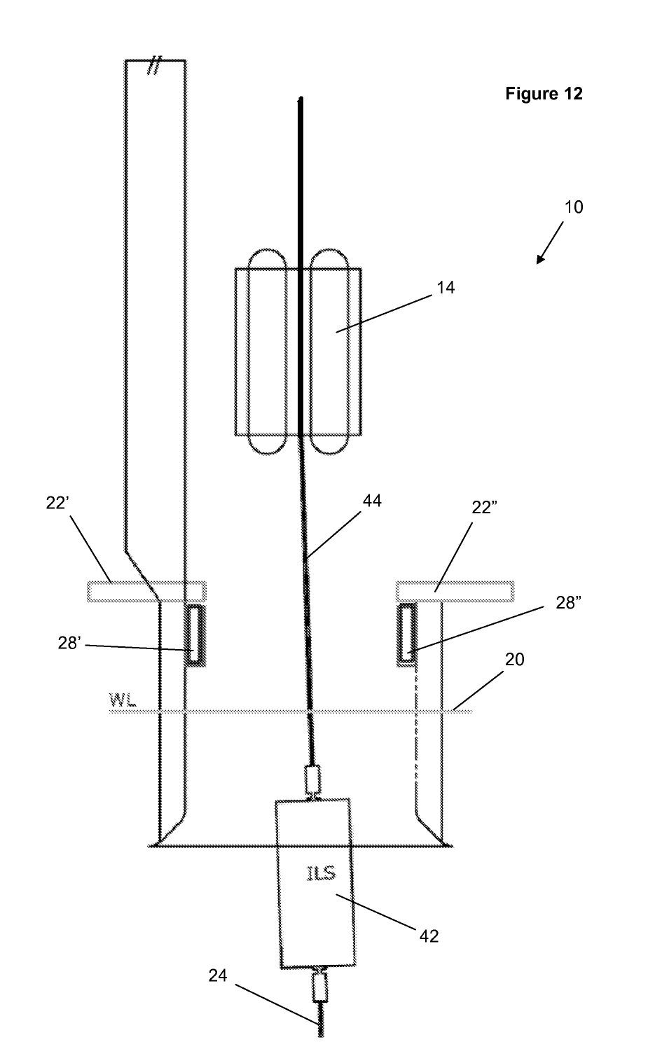

FIG. 12 corresponds to FIG. 11 but shows the in-line structure being lowered into the sea as the tensioner controls the movement of the upper pipe section;

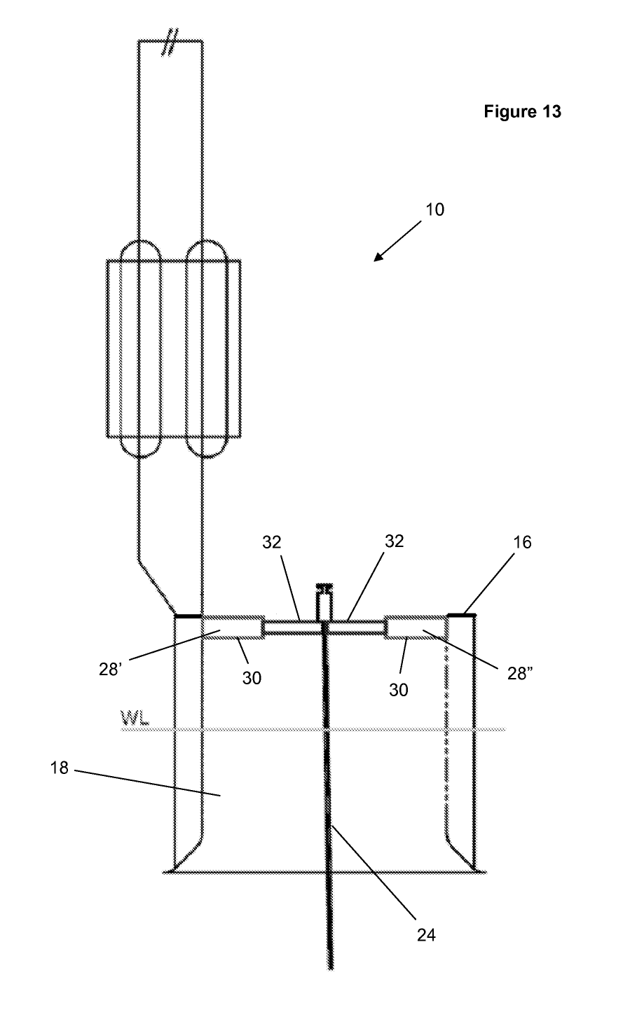

FIG. 13 illustrates a second embodiment of the invention in which a travelling working table serves as the main working table, and shows the lower pipe section clamped by the travelling working table, from which the pipe hangs such that the travelling working table bears the load of the catenary;

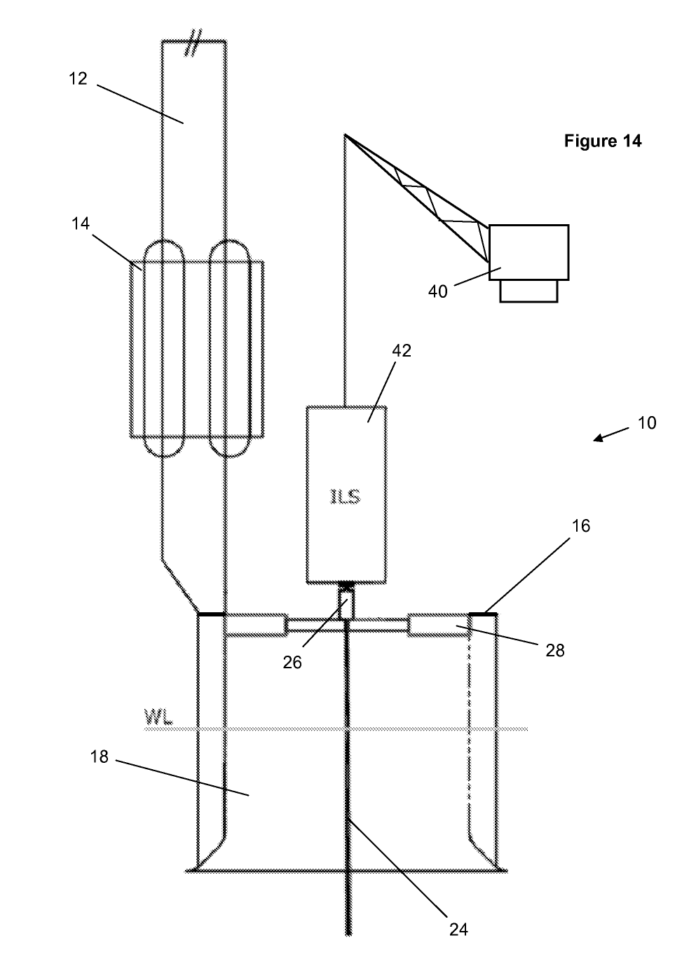

FIG. 14 corresponds to FIG. 13 but shows an in-line structure connected to a connector fitting attached to the top end of the lower pipe section, which still hangs from the travelling working table;

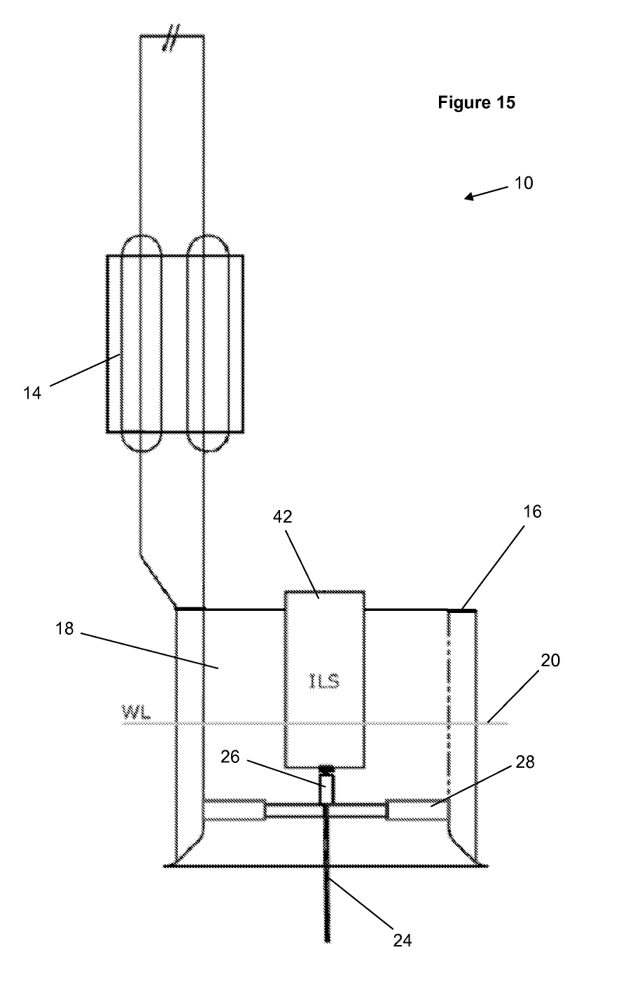

FIG. 15 corresponds to FIG. 14 but shows the travelling working table in a lowered position enabling the in-line structure to be lowered to an extent that provides clearance for a tensioner to be moved over the in-line structure;

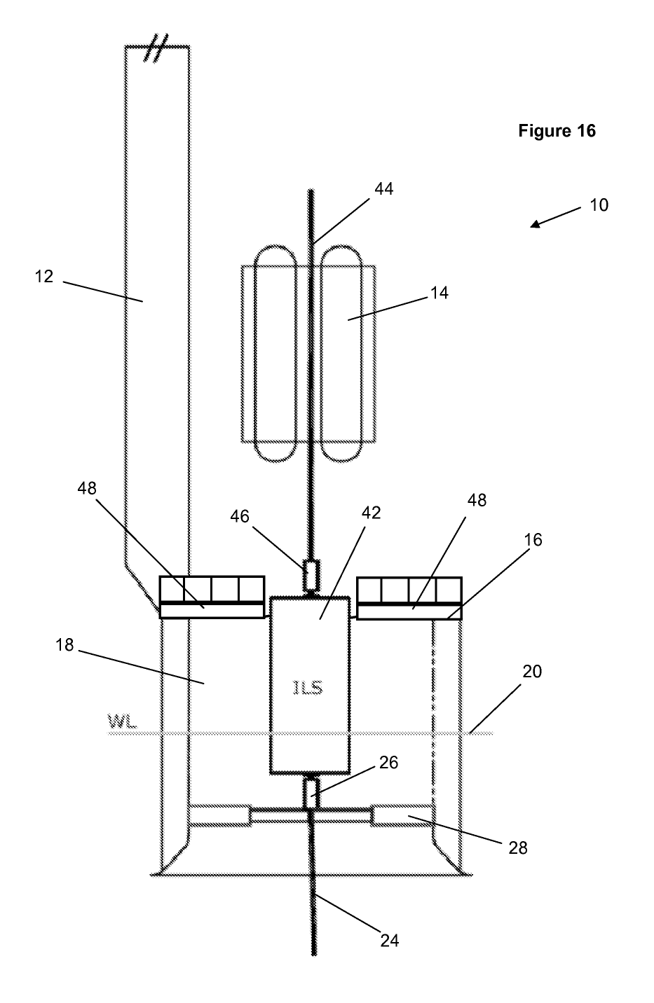

FIG. 16 corresponds to FIG. 15 but shows the tensioner positioned over the in-line structure to engage an upper pipe section connected to the in-line structure via another connector fitting, while the lower pipe section still hangs from the travelling working table which bears the load of the catenary;

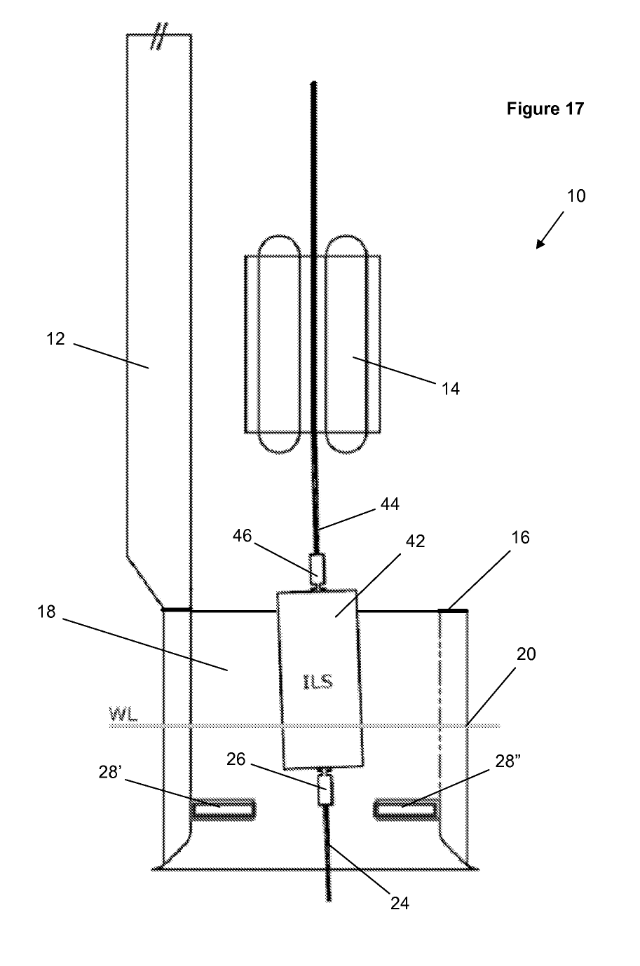

FIG. 17 corresponds to FIG. 16 but shows the travelling working table having released the lower pipe section now that the tensioner engaged with the upper pipe section carries the load of the in-line structure and the catenary;

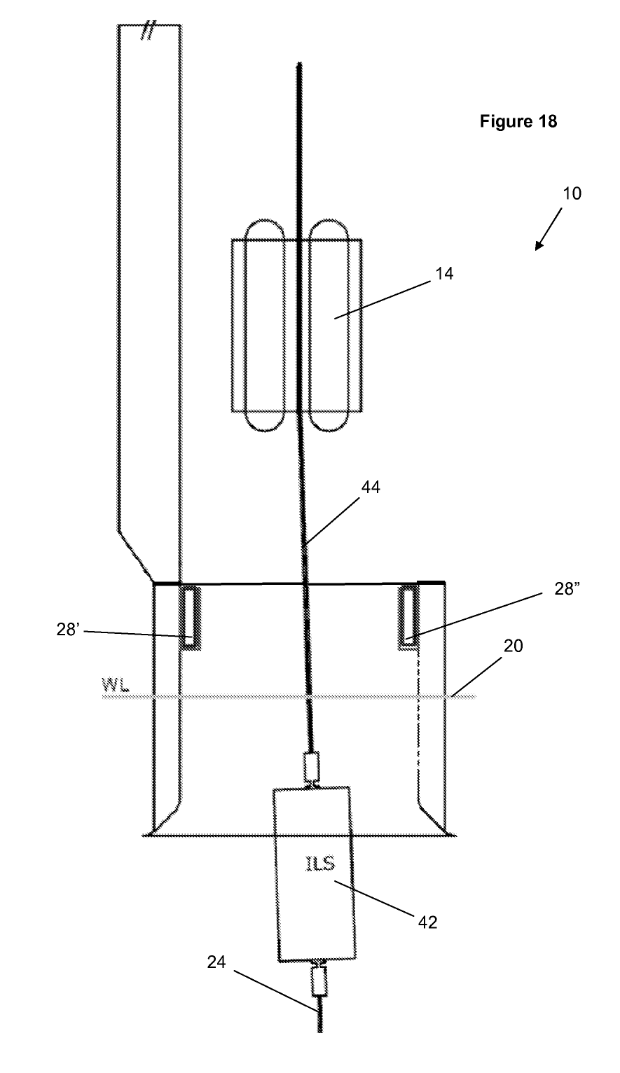

FIG. 18 corresponds to FIG. 17 but shows the travelling working table retracted and stowed and the in-line structure being lowered into the sea as the tensioner controls the movement of the upper pipe section;

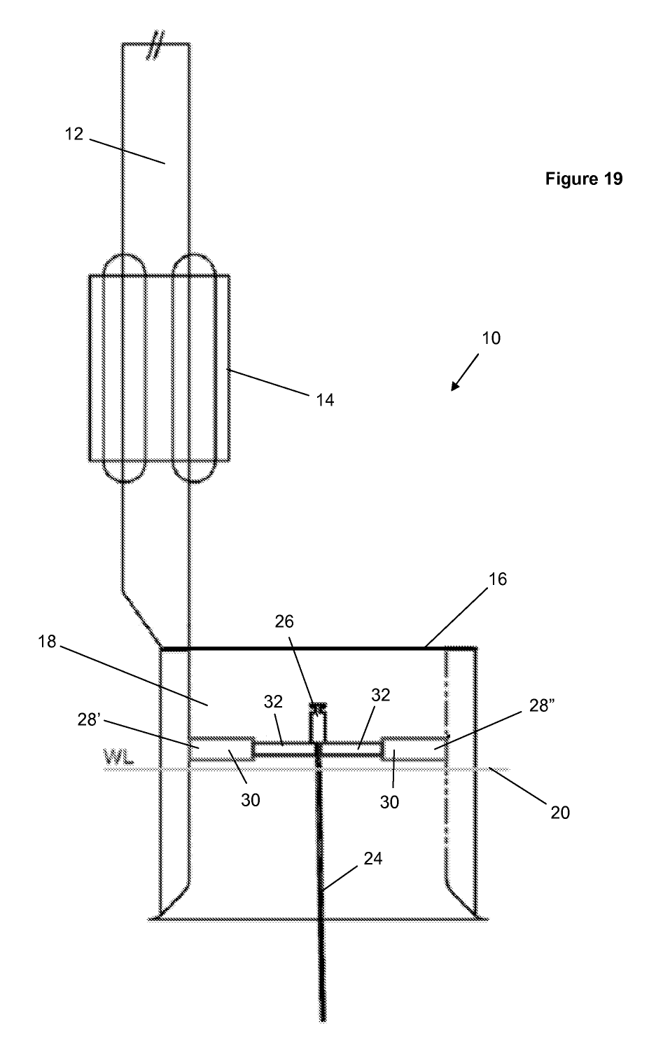

FIG. 19 illustrates a third embodiment of the invention in which a working table is disposed below deck level and does not need to travel vertically when bearing the load of the catenary, here showing the lower pipe section clamped by the working table from which the pipe hangs as a catenary;

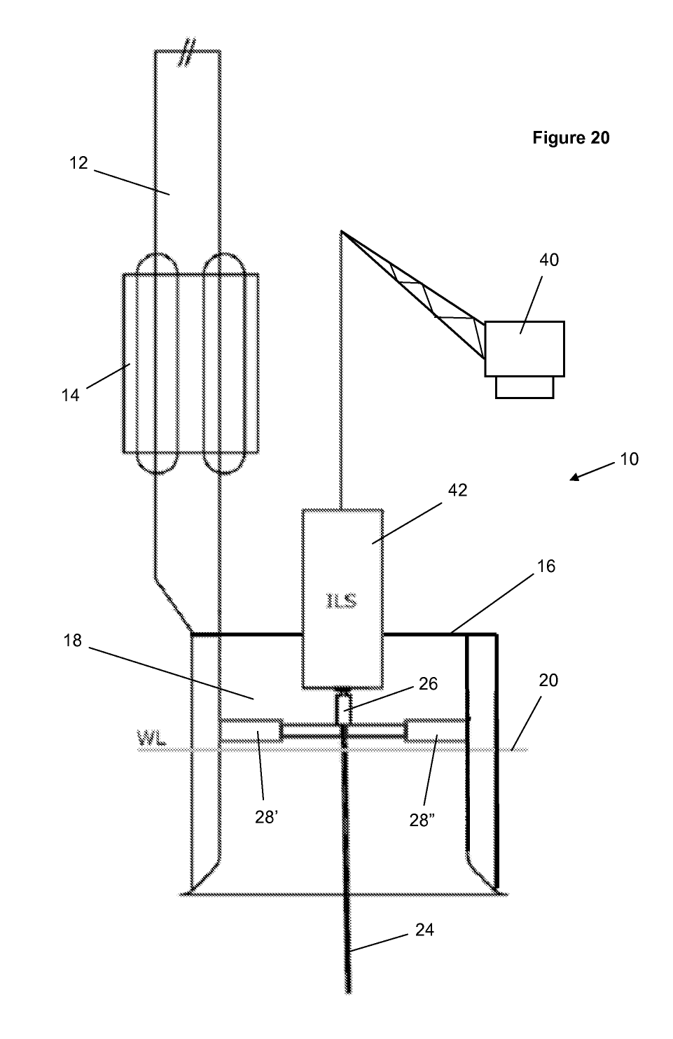

FIG. 20 corresponds to FIG. 19 but shows an in-line structure connected to a connector fitting attached to the top end of the lower pipe section, which still hangs from the working table;

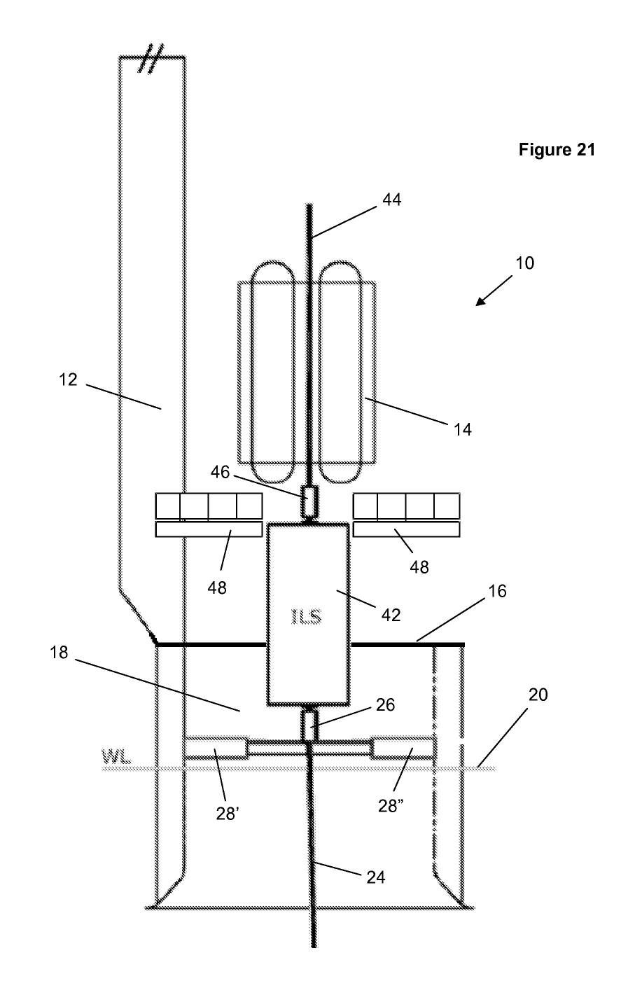

FIG. 21 corresponds to FIG. 20 but shows the tensioner positioned over the in-line structure to engage an upper pipe section connected to the in-line structure via another connector fitting, while the lower pipe section still hangs from the working table which bears the load of the catenary;

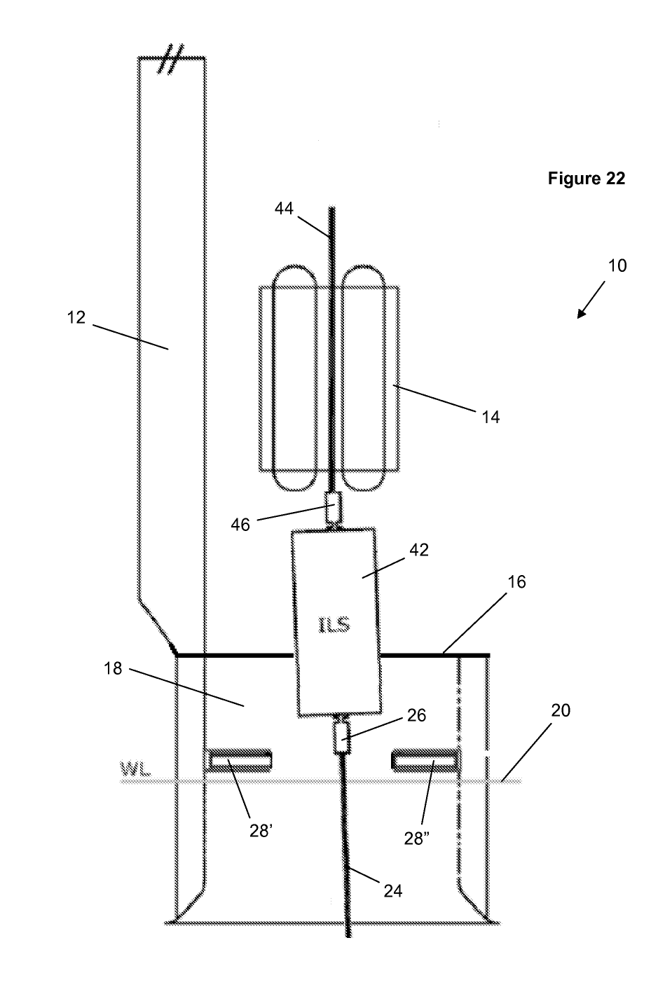

FIG. 22 corresponds to FIG. 21 but shows the working table having released the lower pipe section now that the tensioner engaged with the upper pipe section carries the load of the in-line structure and the catenary; and

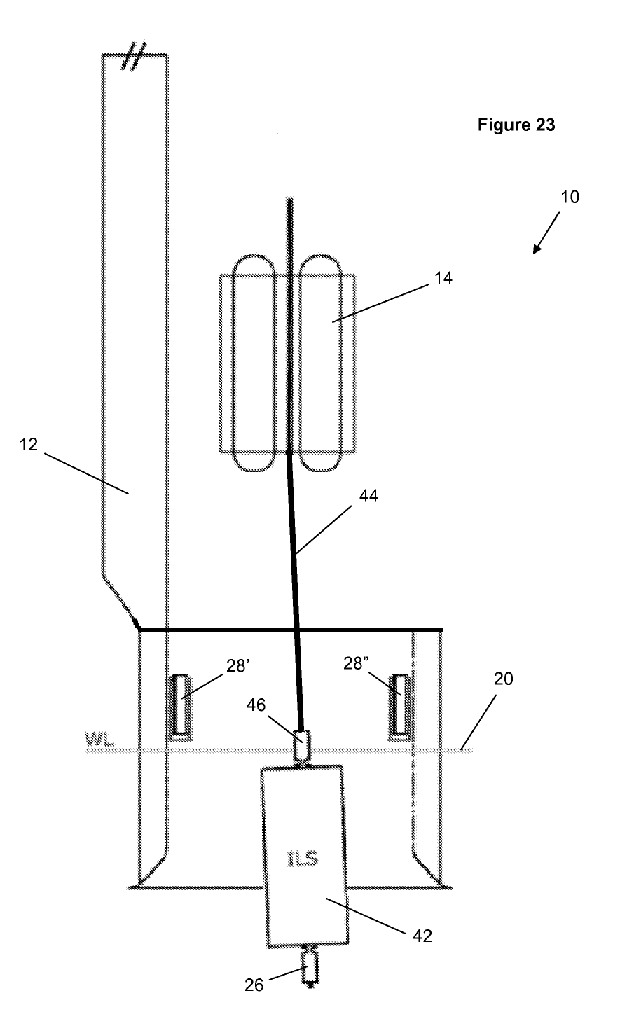

FIG. 23 corresponds to FIG. 22 but shows the working table retracted and stowed and the in-line structure being lowered into the sea as the tensioner controls the movement of the upper pipe section.

Referring firstly to FIGS. 1 and 2 of the drawings, a pipelaying vessel 10 comprises a laytower 12 supporting a tensioner 14 above the deck 16 of the vessel 10. The base of the laytower 12 is situated beside a moonpool 18 extending through the hull of the vessel 10 to below the waterline 20. The laytower 12 may be pivotably mounted to the vessel 10 to suit the departure angle of the pipeline.

At the level of the deck 16, the top of the moonpool 18 is bridged by a main working table 22 having jaws 22′, 22″ that conic together horizontally to clamp a lower pipe section 24. The lower pipe section 24 hangs from the main working table 22 as a catenary curving down to the seabed (not shown), so that the load of the catenary is borne entirely by the main working table 22 at this stage. It will be noted that the lower pipe section 24 hangs from the main working table 22 with a small departure angle from the vertical, in the usual manner. A standard connector fitting 26 is attached to the top end of the lower pipe section 24.

In accordance with the invention, a travelling auxiliary working table 28 is positioned in the moonpool 18 under the main working table 22. The auxiliary working table 28 comprises opposed jaws 28′, 28″, one fitted to each side wall of the moonpool 18. Each jaw 28′, 28″ of the auxiliary working table 28 can be pivoted about a horizontal axis between a stowed state shown in FIG. 1 and a deployed state shown in FIG. 2.

In the stowed state, the jaws 28′, 28″ are stowed generally vertically against each respective side wall of the moonpool 18. In this example, the jaws 28′, 28″ are shown stowed below the waterline 20 although they could be stowed above the waterline 20 instead. In the deployed state, the jaws 28′, 28″ are deployed to a generally horizontal position orthogonal to the respective side walls of the moonpool 18. Initially, the jaws 28′, 28″ do not meet: a gap is left between them to accommodate the departure angle of the lower pipe section 24 hanging from the main working table 22.

Referring now also to the enlarged view of FIG. 3, each jaw 28′, 28″ of the auxiliary working table 28 comprises a base portion 30 and a clamp portion 32 that is extendable telescopically from within the base portion 30 when the jaw 23′, 28″ is in the deployed state. Each base portion 30 is pivotably attached to a respective carriage 34 to enable angular movement of the jaws 28′, 28″ between the vertical stowed state and the horizontal deployed state. The carriages 34 run on respective vertical rails 36 to effect synchronised vertical movement of the jaws 28′, 28″ and hence of the auxiliary working table 28.

The clamp portions 32 are moved relative to the base portions 30, the base portions 30 are moved relative to the carriages 34 and the carriages 34 are moved relative to the rails 36 by a suitable drive system such as an arrangement of hydraulic actuators or motors whose movements are controlled and synchronised by a control system.

The drive system and the control system are omitted from the drawings, as those skilled in the art will readily appreciate how suitable drive and control systems could be configured.

Moving on now to FIG. 4, the carriages 34 have moved upwardly along the rails 36 of FIG. 3 to raise the deployed auxiliary working table 28 to a position immediately under the main working table 22. The main working table 22 still clamps the lower pipe section 24 at this stage.

Then, as shown in FIG. 5, the lower pipe section 24 is lifted from the main working table 22 by an A&R (abandonment and recovery) winch 38. Once the A&R winch 38 takes the load of the lower pipe section 24, the jaws 22′, 22″ of the main working table 22 separate horizontally to release the lower pipe section 24 as shown.

Next, FIG. 6 shows the lower pipe section 24 having been lowered by the A&R winch 38 of FIG. 5 to the level of the auxiliary working table 28. Here, as the clamp portions 32 extend relative to the base portions 30, the jaws 28′. 28″ have dosed around the lower pipe section 24 to allow the load to be transferred from the A&R winch 38 to the auxiliary working table 28. The lower pipe section 24 now hangs as a catenary from the auxiliary working table 28.

Once the auxiliary working table 28 bears the load of the lower pipe section 24, a main crane 40 of the vessel 10 positions an in-line structure (ILS) 42 such as an in-line tee as shown in FIG. 7. The ILS 42 is lifted onto and attached to the connector fitting 26 at the top end of the lower pipe section 24. Once the ILS 42 has been lifted onto the connector fitting 26, the auxiliary working table 28 may support the ILS 42 with suitable support structures that are omitted from the schematic view of FIG. 7. The lifting tackle of the main crane 40 may then be detached from the ILS 42.

The use of a main crane 40 is optional: other lifting apparatus on the vessel 10 such as winch or an overhead crane may be used instead.

It will be noted that the height or vertical length of the ILS 42 represented in FIG. 7 as X exceeds the clearance Y available between the underside of the tensioner 14 and the top of the main working table 22, when taking into account the height Z of the connector fitting 26 above the auxiliary working table 28. Without the benefit of the invention, this would prevent the tensioner 14 being moved horizontally relative to the laytower 12 to a position over the ILS 42, especially if allowing further clearance for an upper connector fitting atop the ILS 42. It follows that without the benefit of the invention, this problem could only be solved by—disadvantageously—positioning the tensioner 14 much higher on the laytower 12. In contrast, the invention allows the ILS 42 to be lowered relative to the main working table 22 to allow the underside of the tensioner 14 to clear the top of the ILS 42 when the tensioner 14 is moved horizontally, and to allow further clearance for an upper connector fitting atop the ILS 42. This allows the tensioner 14 to be kept beneficially low on the laytower 12.

Thus, the auxiliary working table 28 is lowered by downward movement of the carriages 34 along the rails 36 of FIG. 3 to lower the ILS 42 as shown in FIG. 8.

Advantageously the upper end of the ILS 42 is now at or near to the level of the main working table 22 for ease of access by workers. The lower end of the ILS 42 is lowered below the waterline 20 as shown if needs be. The jaws 22′, 22″ of the main working table remain apart to provide clearance for the ILS 42 to pass between them. Lowering the auxiliary working table 28 in this way enables the ILS 42 to be lowered to an extent that provides ample clearance for the tensioner 14 to be moved horizontally relative to the laytower 12 to a position over the ILS 42 as shown in FIG. 9.

In FIG. 9, the tensioner 14 has been positioned over the lowered ILS 42 so as to embrace and tractionally engage an upper pipe section 44. The upper pipe section 44 may, for example, have been unspooled from a reel (not shown) on the ship 10. The upper pipe section 44 has been connected to the ILS 42 via an upper connector fitting 46.

Engagement of the tensioner 14 with the upper pipe section 44 in this way enables the jaws 28′, 28″ of the auxiliary working table 28 to separate to release the lower pipe section 24 as shown in FIG. 10. This is achieved by retracting the clamp portions 32 of the jaws 28′, 28″ relative to the base portions 30. The tensioner 14 engaged with the upper pipe section 44 now bears the combined load of the ILS 42 and the lower pipe section 24. The ILS 42 is then free to adopt the departure angle of the pipeline as shown. The jaws 22′, 22″ of the main working table 22 may be further separated as shown to maximise clearance for lateral movement of the ILS 42.

FIG. 11 shows the optional step of using the tensioner 14 to haul in the ILS 42 slightly if it is necessary to provide clearance for the jaws 28′, 28″ of the auxiliary working table 28 to return to the stowed state against the side walls of the moonpool 18.

FIG. 12 shows the ILS 42 and the lower pipe section 24 being lowered into the sea as the tensioner 14 controls the downward movement of the upper pipe section 44. The process continues until the pipeline is abandoned to the seabed, normally after the addition of a pipeline end terminal (PLET), or until a further ILS is to be added to the pipeline. In that case, the above steps may be repeated once the main working table 22 has again clamped the upper end of the pipeline as shown in FIG. 1.

The first embodiment shown in FIGS. 1 to 12 illustrates how apparatus of the invention may be retrofitted to a vessel by adding a travelling auxiliary working table under an existing main working table. In a broad sense, however, the invention also extends to arrangements in which a travelling working table entirely replaces the main working table. In this respect, reference is made to the second embodiment illustrated in FIGS. 13 to 18 of the drawings. This arrangement is apt to be built into a vessel from the design stage.

FIGS. 13 to 18 correspond generally to FIGS. 6 to 10 and 12, but they omit the main working table 22. Like numerals are used for like parts, but as the auxiliary working table 28 of the first embodiment serves as the sole working table in the second embodiment, that feature is referred to simply as a ‘travelling working table’ in the description of FIGS. 13 to 18 that follows. The travelling working table 28 can be raised to the level of the deck 16 and lowered into the moonpool 18.

So, FIG. 13 shows the lower pipe section 24 having been moved by the A&R winch 38 of FIG. 5 to the travelling working table 28. Here, as the clamp portions 32 extend relative to the base portions 30, the jaws 28′, 28″ have closed around the lower pipe section 24 to allow the load to be transferred from the A&R winch 38 to the travelling working table 23. The lower pipe section 24 now hangs as a catenary from the travelling working table 28.

Once the travelling working table 28 bears the load of the lower pipe section 24, a main crane 40 or other lifting apparatus of the vessel 10 positions an in-line structure (ILS) 42 such as an in-line tee as shown in FIG. 14. The ILS 42 is lifted onto and attached to the connector fitting 26 at the top end of the lower pipe section 24.

As before, the height or vertical length of the ILS 42 exceeds the clearance available between the underside of the tensioner 14 and the deck 16. The invention allows the ILS 42 to be lowered relative to the deck 16 to allow the underside of the tensioner 14 to clear the top of the ILS 42 when the tensioner 14 is moved horizontally, and to allow further clearance for an upper connector fitting atop the ILS 42. This allows the tensioner 14 to be kept beneficially low on the laytower 12.

Thus, the travelling working table 28 is lowered by downward movement of the carriages 34 along the rails 36 of FIG. 3 to lower the ILS 42 as shown in FIG. 15. Advantageously the upper end of the ILS 42 is now at or near to the level of the deck 16 for ease of access by workers, assisted by a moving platform 48 that may be extended from the deck 16 across the top of the moonpool 18 toward the ILS 42 as shown in FIG. 16. The lower end of the ILS 42 is lowered below the waterline 20 as shown in FIG. 15 if needs be. Lowering the travelling working table 28 in this way enables the ILS 42 to be lowered to an extent that provides ample clearance for the tensioner 14 to be moved horizontally relative to the laytower 12 to a position over the ILS 42 as shown in FIG. 16.

In FIG. 16, the tensioner 14 has been positioned over the lowered ILS 42 as to embrace and tractionally engage an upper pipe section 44, which has been connected to the ILS 42 via an upper connector fitting 46.

Engagement of the tensioner 14 with the upper pipe section 44 in this way enables the jaws 28′, 28″ of the travelling working table 28 to separate to release the lower pipe section 24 as shown in FIG. 17. This is achieved by retracting the clamp portions 32 of the jaws 28′, 28″ relative to the base portions 30. The tensioner 14 engaged with the upper pipe section 44 now bears the combined load of the ILS 42 and the lower pipe section 24. The ILS 42 is then free to adopt the departure angle of the pipeline as shown. The platform 48 shown in FIG. 16 may be removed or moved aside to maximise clearance for lateral movement of the ILS 42.

FIG. 18 shows the ILS 42 and the lower pipe section 24 being lowered into the sea as the tensioner 14 controls the downward movement of the upper pipe section 44. The process continues until the pipeline is abandoned to the seabed, normally after the addition of a pipeline end terminal (PLET), or until a further ILS is to be added to the pipeline. In that case, the above steps may be repeated once the travelling working table 28 has again clamped the upper end of the pipeline as shown in FIG. 13.

Turning finally to FIGS. 19 to 23 of the drawings, these correspond generally to FIGS. 13, 14 and 18 to 18 and again, like numerals are used for like parts. FIGS. 19 to 23 illustrate a third embodiment of the invention, in which a working table 28 comprising jaws 28′, 28″ is disposed in the moonpool 18 below the level of the deck 16, just above the waterline 20. In this embodiment, the working table 28 does not travel vertically in use when bearing the load of the catenary although—optionally but advantageously—there is provision for stowing the jaws 28′, 28″ of the working table after use.

FIG. 19 shows the lower pipe section 24 having been moved by the A&R winch 38 of FIG. 5 to the working table 28. The clamp portions 32 have been extended relative to the base portions 30 to close the jaws 28′, 28″ around the lower pipe section 24. This allows the load to be transferred from the A&R winch 38 to the working table 28, so that the lower pipe section 24 can hang as a catenary from the working table 28.

As shown in FIG. 20, once the working table 28 bears the load of the lower pipe section 24, a main crane 40 or other lifting apparatus of the vessel 10 positions an in-line structure (ILS) 42 such as an in-line tee. The ILS 42 is lifted onto and attached to the connector fitting 26 at the top end of the lower pipe section 24, protruding above the working table 28.

Again, the height or vertical length of the ILS 42 plus the connector fitting 26 exceeds the clearance available between the underside of the tensioner 14 and the deck 16. Like the preceding embodiments, the third embodiment of the invention allows the ILS 42 to be lowered relative to the deck 16 to allow the underside of the tensioner 14 to clear the top of the ILS 42, including an upper connector fitting atop the ILS 42, when the tensioner 14 is moved horizontally. This keeps the tensioner 14 at a beneficially low position on the laytower 12,

FIG. 21 shows an elevated moving platform 48 that may be extended from the laytower 12 or from the deck 16. The platform 48 facilitates access by workers to the upper end of the ILS 42 for attaching an upper connector fitting 46 connected to an upper pipe section 44. Lowering the ILS 42 onto the working table 28 recessed into the moonpool 18 below the deck 16 provides clearance for the tensioner 14 to be moved horizontally relative to the laytower 12 to a position over the ILS 42 as shown in FIG. 21. There, the tensioner 14 embraces and tractionally engages the upper pipe section 44 connected to the ILS 42 via the upper connector fitting 46.

Once the tensioner 14 has been engaged with the upper pipe section 44 in this way, the clamp portions 32 retract relative to the base portions 30 of the jaws 28′, 28″ of the working table 28 to release the lower pipe section 24 as shown in FIG. 22. The ILS 42 is then free to adopt the departure angle of the pipeline as shown, with the tensioner 14 engaged with the upper pipe section 44 now bearing the combined load of the ILS 42 and the lower pipe section 24. The platform 48 shown in FIG. 21 has been removed in FIG. 22 to give clearance for lateral movement of the ILS 42 but may simply be moved aside.

Finally, FIG. 23 shows the ILS 42 being lowered into the sea as the tensioner 14 controls the downward movement of the upper pipe section 44. The process continues until the pipeline is abandoned to the seabed or until a further ILS is to be added to the pipeline.

FIGS. 18 to 22 shown the jaws 28′, 28″ in a deployed state, hinged to a generally horizontal position orthogonal to the respective side walls of the moonpool 18. FIG. 23 shows the jaws 28′, 28″ in a stowed state, hinged generally vertically against each respective side wall of the moonpool 18. This maximises clearance for lateral movement of the ILS 42 within the moonpool 18. In this example, the jaws 28′, 28″ are shown stowed above the waterline 20 although they could be stowed below the waterline 20 instead.

Many other variations are possible within the inventive concept. For example, a laying slot, which is typically situated at the stern of the vessel, could be used instead of a moonpool. Also, it would be possible to support the ILS on the auxiliary working table with the assistance of a crane or other lifting apparatus while the auxiliary working table is being lowered to provide clearance for horizontal movement of the tensioner.

Whilst the pipe illustrated in the drawings is flexible, the invention is not restricted to use with flexible pipe. It is noted in this respect that nominally rigid pipe has some flexibility and may be spooled onto a reel and straightened following plastic deformation. The invention is applicable to any essentially vertical pipelaying system that involves the use of a pipe-supporting clamp and retractable tensioners, and the installation of in-line structures.

1. A pipelaying vessel in combination with a pipe incorporating an in-line structure, the vessel comprising:
a clamp supporting a catenary of the pipe extending from the vessel to the seabed, the clamp being located at a level below, or being movable to a level below, a working deck of the vessel, the in-line structure being positioned above the clamp, connected to an upper end of the catenary supported by the clamp; and
a tensioner that is positioned with a vertical clearance above the working deck and is movable transversely with respect to a launch axis of the pipe from a retracted position to a deployed position above the in-line structure
wherein the in-line structure has a height along the launch axis that exceeds the vertical clearance between the working deck and the tensioner and the level of the clamp is below the working deck by a distance sufficient to accommodate the in-line structure under the tensioner when the tensioner is in the deployed position.

2. (canceled)

3. The pipelaying vessel of claim 1, wherein the height of the in-line structure along the launch axis includes one or more connectors for connecting the in-line structure to upper and/or lower sections of the pipe.

4. The pipelaying vessel of claim 1, wherein the clamp is situated on a hull wall of the vessel extending from the working deck to below a waterline of the vessel.

5. The pipelaying vessel of claim 4, wherein the clamp is situated in a laying slot or moonpool of the vessel.

6. The pipelaying vessel of claim 1, wherein the clamp comprises elements that are movable between stowed and deployed states.

7. The pipelaying vessel of claim 6, wherein, in the stowed state, the elements of the clamp lie against or generally parallel with hull walls of the vessel.

8. The pipelaying vessel of claim 6, wherein, in the deployed state, the elements of the clamp lie proud of hull walls of the vessel.

9. The pipelaying vessel of claim 8, wherein the elements are oriented generally orthogonally with respect to the hull walls in the deployed state.

10. The pipelaying vessel of claim 1, wherein elements of the clamp are pivotable with respect to hull walls of the vessel.

11. The pipelaying vessel of claim 1, wherein elements of the clamp each comprise a base portion and a clamp portion that is movable with respect to the base portion toward and away from the clamp portion of another element of the clamp.

12. A subsea pipelaying method, comprising:
supporting a catenary of pipe extending to the seabed from a clamp located at, or movable to, a level below a working deck of a pipelaying vessel;
connecting an in-line structure to an upper end of the catenary supported by the clamp when the clamp is below the working deck or before moving the clamp below the working deck; and
with the clamp below the working deck to allow a tensioner positioned above the working deck to clear the top of the in-line structure, moving the tensioner transversely with respect to a launch axis of the pipe from a retracted position to a deployed position above the in-line structure.

13. The subsea pipelaying method of claim 12, wherein the in-line structure has a height along the launch axis greater than a vertical clearance between the tensioner and the working deck, and when the tensioner is in the deployed position, the in-line structure is accommodated under the tensioner by extending at least partially below the working deck.

14. The subsea pipelaying method of claim 12, comprising lowering the clamp relative to the working deck while the clamp supports the catenary.

15. The subsea pipelaying method of claim 14, comprising connecting the in-line structure to the upper end of the supported catenary before lowering the clamp and the in-line structure.

16. The subsea pipelaying method of claim 12, comprising lowering the in-line structure onto the upper end of the supported catenary when the clamp is below the working deck.

17. The subsea pipelaying method of claim 15, comprising moving the tensioner into the deployed position after lowering the in-line structure at least partially below the working deck.

18. The subsea pipelaying method of claim 12, wherein an upper end of the in-line structure is brought substantially to the level of the working deck.

19. The subsea pipelaying method of claim 12, wherein a platform is moved toward the upper end of the in-line structure for access by workers thereto.

20. The subsea pipelaying method of claim 12, comprising moving elements of the clamp between stowed and deployed states.

21. An apparatus for laying pipe from a vessel, the pipe including at least one in-line structure, wherein the apparatus comprises:
a travelling clamp for clamping the pipe, the clamp being movable to lower the clamped pipe and an in-line structure to be installed on the pipe; and
a tensioner that is movable transversely with respect to the direction of movement of the clamp when the clamp has lowered to an extent necessary to accommodate the in-line structure beneath the tensioner.

22. An apparatus for laying pipe from a vessel, the pipe including at least one in-line structure, wherein the apparatus comprises a first clamp positioned at a level on the vessel, a tensioner positioned on the vessel at a level above that of the first clamp, and a second clamp positioned on the vessel at a level below that of the first clamp, each of the clamps and the tensioner being individually capable of supporting a catenary of pipe hanging therefrom; wherein a gap to accommodate the in-line structure extends from the tensioner through the level of the first clamp to the second clamp.

23. The apparatus of claim 22, wherein the tensioner is movable generally horizontally to a position above the in-line structure when the in-line structure has been positioned between the levels of the second clamp and the tensioner.

24. The apparatus of claim 22, wherein the second clamp is movable vertically with respect to the tensioner.

25. The apparatus of claim 24, wherein the second clamp is movable vertically with respect to the first clamp.

26. The apparatus of claim 22, wherein the first clamp comprises jaws that move together to clamp the pipe and that move apart, or otherwise aside, to allow the in-line structure to lie between the second clamp and the tensioner.

27. The apparatus of claim 21 in combination with pipe to be laid from a vessel, the pipe incorporating an in-line structure whose height is less than a gap between the tensioner and the clamp but greater than a gap between the tensioner and a working deck of the vessel.

28. A method using the apparatus of claim 21, the method comprising clamping the pipe and lowering the clamped pipe and an in-line structure to an extent necessary to accommodate the in-line structure beneath the tensioner that then moves laterally to a position over the in-line structure.

29. A method using the apparatus of claim 22, the method comprising clamping the pipe at the second clamp, connecting the in-line structure to the clamped pipe, and lowering the clamped pipe and in-line structure through or past the first clamp to accommodate the in-line structure beneath the tensioner.

30. The method of claim 29, wherein the tensioner is moved generally horizontally to a position above the in-line structure when the in-line structure has been lowered to an extent sufficient to allow clearance for that movement of the tensioner.

31. The method of claim 29, comprising moving jaws of the first clamp apart or aside to allow the in-line structure to move through or past the first clamp.

32. (canceled)
